(19) United States
(12) Patent Application Publication
(10) Pub. No.: US 2016/0017149 A1
(43) Pub. Date: Jan. 21, 2016

(54) PROCESS FOR THE PRODUCTION OF POLYMER MODIFIED BITUMEN USING NITROGEN RICH POLYCYCLIC AROMATIC HYDROCARBON

(71) Applicant: Indian Oil Corporation Limited, Bandra (East), Mumbai (IN)

(72) Inventors: Veena YADAV, Faridabad (IN); Dhanesh KUMAR, Faridabad (IN); Naduhatty Selai RAMAN, Faridabad (IN); Anurag Ateet GUPTA, Faridabad (IN); Biswapriya DAS, Faridabad (IN); Ravinder Kumar MALHOTRA,, Faridabad (IN)

(21) Appl. No.: 14/803,390

(22) Filed: Jul. 20, 2015

(30) Foreign Application Priority Data
Jul. 19, 2014 (IN) 2335/MUM/2014

(51) Int. Cl. C08L 95/00

(52) U.S. Cl. CPC C08L 95/00; C08L 2555/80

(57) ABSTRACT

The present invention relates to a polymer modified bitumen composition comprising a petroleum vacuum residue, a nitrogen rich polycyclic aromatic hydrocarbon and a functionalized polymer having enhanced softening point, good antistripping effect, enhanced elastic recovery higher performance grade and low temperature creep stiffness effect. The present invention also relates to processes for the preparation of polymer modified bitumen composition.

### FIELD OF THE INVENTION

The present invention relates to a polymer modified bitumen (PMB) composition having high stability, reduced deformation, reduced temperature susceptibility, enhanced resistance to water stripping and meets specifications for all grades of PMB, more particularly for PMB as per IS 15462:2004(Type-B) and IRC: SP: 53-2010, without using catalyst or milling process. The present invention also relates to a process for preparation of all grades of PMB including PMB as per IS 15462:2004: Type-B.

### BACKGROUND OF THE INVENTION

Asphalt has viscoelastic properties which allow and resist it to flow. The viscous properties dominate at high temperature which allows the asphalt to flow. The elastic properties dominate at lower temperature which resists the asphalt to flow. These natural properties of asphalt can be modified by incorporating certain polymers. The polymer modified asphalt obtained by incorporation of polymers has some enhanced properties without affecting the desired properties of asphalt.

It is well known in literature that polymer modified asphalt exhibits greater resistance to rutting, thermal cracking, and decreased fatigue damage and temperature susceptibility. Typically polymer modified asphalt are non-viscous as compared to unmodified asphalt and tend to show improved adhesive bonding to aggregates.

The functionalized polymers that do not separate in a mixture of asphalt and polymer during storage have a good compatibility with asphalt. So the compatibility of functionalized polymer with asphalt determines that up to how much extent it improves asphalt properties. Highly compatible polymers are very effective for the enhancement of certain properties of asphalt. Cross linking polymers having reactive functional group have been used with asphalt for better compatibility.

It has been found that various functionalized polymers have been added to asphalt to enhance physical and rheological properties. Polymer modified asphalt is useful in a variety of applications including road construction, maintenance and roofing. Conventional asphalt is not effective in such application because of lack of sufficient elasticity and plasticity. By incorporation of elastomeric/plastomeric types of polymers which are selected from butyl, polybutadiene, polyisoprene, ethylene/vinyl acetate copolymer, polyacrylate, ethylene/propylene/diene terpolymer etc., the characteristics of road asphalt can be highly improved.

U.S. Pat. No. 6,011,095 relates to a composition comprising the blends of polymer and acid to result in cost effective polymer modified asphalt. Ethylene/butyl acrylate/glycidyl methacrylate terpolymer (EnBAGMA) is an elastomeric polymer which is commercially available from E.I. DuPont under the trade name Elvaloy® RET improves asphalt properties at low concentration. Ethylene acrylate is commercially available from DuPont under the trade name of Elvaloy® AC. EP 1907481A1 relates the use of combination of Elvaloy® RET with Elvaloy® AC for modification of asphalt.

U.S. Pat. No. 5,023,282A relates to asphalt cement composition which utilize petroleum asphalt, natural asphalt, reactive oil and an elastomeric polymer for the production of superior asphalt cement with low viscosity during application followed by high viscosity, toughness and tenacity after curing on highway.

It is found that using the preparation methods as disclosed in prior art, PMB-40 as per IS 15462:2004: Type-B could not be prepared, either by using functionalized polymer alone or along with catalyst, due to the formation of gel with high concentration of polymer in bitumen (either by intramolecular cross linking of functionalized polymer or by intermolecular cross linking due to the reaction of functionalized polymer and catalyst like polyphosphoric acid).

Present invention overcomes this particular problem of preparation of high performance grade PMB-40 as per IS 15462:2004: Type-B by using nitrogen rich polycyclic hydrocarbon along with functionalized polymer without using catalyst to get polymer modified bitumen which shows resistance to high temperature rutting and low temperature thermal cracking without affecting the desired properties of asphalt.

### SUMMARY OF THE INVENTION

The present invention relates to a polymer modified bitumen composition comprising a petroleum vacuum residue, a nitrogen rich polycyclic aromatic hydrocarbon and a functionalized polymer. The petroleum vacuum residue is produced from high sulphur crude or low sulphur crude or mixture thereof. The petroleum vacuum residue has a penetration range of 50 to 150 dmm. Preferably the petroleum vacuum residue has a penetration range of 80 to 150 dmm.

The nitrogen rich polycyclic aromatic hydrocarbon comprises a polycyclic aromatic hydrocarbon condensed with a heterocyclic ring containing nitrogen. The heterocyclic ring containing nitrogen is selected from pyrrole, pyridine, pyrimidine, porphyrine ring or contains amide functional groups.

The nitrogen rich polycyclic aromatic hydrocarbon is present in the range of 1 to 6 wt % based on the total weight of the composition. The functionalized polymer is a copolymer having ethylene or propylene backbone with side chains having functional groups. The functional groups comprise methacrylates, butyl acrylates vinyl ether, glycidyl methacrylate, glycidyl vinyl ether and epoxides. The functionalized polymer is present in the range of 1.5-3 wt % based on the total weight of the composition.

The present invention also relates to a process for the preparation of a polymer modified bitumen composition comprising:
(a) reacting a functionalized polymer with a nitrogen rich polycyclic aromatic hydrocarbon modified vacuum residue to obtain a polymer modified bitumen composition.

The step (a) is carried out within 6 hours in the absence of a catalyst. Step (a) is carried out in a batch reactor without milling.

In yet another embodiment of the invention, the invention also relates to a process for the preparation of a polymer modified bitumen composition comprising:
i. heating petroleum vacuum residue;
ii. adding nitrogen rich polycyclic aromatic hydrocarbon to the heated petroleum residue of step i.;
iii. mixing properly or dispersing homogenously the mixture of step ii. with the help of an agitator;
iv. adding functionalized polymer to the mixture of step iii.
v. mixing properly or dispersing homogenously the mixture of step iv. with the help of an agitator to obtain a polymer modified bitumen.

The mixing step iii. is carried out for half to one hour and the mixing step v. is carried out for 4-5 hours. The entire process was carried out at a temperature of 165° C. to 185° C.

The polymer modified bitumen composition of the present invention has enhanced softening point of 66-67° C., good antistripping effect of 95-98%, enhanced elastic recovery of 71%, higher performance grade of 76-22 and low temperature creep stiffness effect of 0.300 to 0.520.

### DETAILED DESCRIPTION OF THE INVENTION

While the invention is susceptible to various modifications and alternative forms, specific embodiment thereof will be described in detail below. It should be understood, however that it is not intended to limit the invention to the particular forms disclosed, but on the contrary, the invention is to cover all modifications, equivalents, and alternatives falling within the scope of the invention as defined by the appended claims.

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

The terms “comprises”, “comprising”, or any other variations thereof, are intended to cover a non-exclusive inclusion, such that one or more processes or composition/s or systems or methods proceeded by “comprises . . . a” does not, without more constraints, preclude the existence of other processes, sub-processes, composition, sub-compositions, minor or major compositions or other elements or other structures or additional processes or compositions or additional elements or additional features or additional characteristics or additional attributes.

### DEFINITIONS

For the purposes of this invention, the following terms will have the meaning as specified therein:

Asphalt/bitumen: In the present invention, the term “asphalt” is meant to be inclusive of materials designated by the term “bitumen” and no distinction is made herein between the two terms.

Nitrogen rich polycyclic aromatic hydrocarbon: The nitrogen rich polycyclic aromatic hydrocarbon includes polycyclic aromatic hydrocarbon enriched with heterocyclic ring containing nitrogen like pyrrole, pyridine, pyrimidine, porphyrine ring, amide functional groups, etc.

Functionalized polymer: Functionalized polymer includes ethylene or propylene back bone with side chain having functional groups like methacrylates, vinyl ether, glycidyl methacrylate, glycidyl butyl acrylates, glycidyl vinyl ether, epoxides etc.

Polymer modified bitumen (PMB): Bitumen modified with one or more polymer to enhance the properties of bituminous pavement is known as polymer modified bitumen.

Penetration: Penetration is measured, in 1/10 mm, with a Penetrometer by means of which a standard needle is penetrated into the sample under test conditions. (Temperature=25° C., Load=100 g, Time=5 s)

Petroleum vacuum residue: Petroleum vacuum residue comprises asphalt/bitumen bearing a penetration range from 50 to 150.

The present invention discloses a polymer modified bitumen (PMB) composition having high stability, reduced deformation, reduced temperature susceptibility, and enhanced resistance to water stripping as compared to functionalized polymer modified bitumen.

It has been discovered that asphalt can be made compatible by modifying with nitrogen rich polycyclic aromatic hydrocarbon to facilitate reaction with functionalized polymer to get all grades of polymer modified asphalt with enhanced rheological properties. The asphalt which can be modified in accordance with the invention includes nitrogen rich polycyclic aromatic hydrocarbon, functionalized polymer without using catalyst. The polymer modified asphalt composition of the present invention can be used for highly trafficked and stressed highways in extreme climatic conditions and high rainfall.

The developed polymer modified bitumen meets specifications of IS 15462:2004(Type-B) and IRC: SP: 53-2010 with penetration range of 30 to 50, 50 to 90 and 90 to 150 dmm with acceptable elastic recovery.

In accordance with the present invention, polymer modified bitumen (PMB) is disclosed comprising a petroleum vacuum residue, a nitrogen rich polycyclic aromatic hydrocarbon and a functionalized polymer. In an embodiment, the vacuum residue is produced from high sulphur crude or low sulphur crude or mixture thereof. In another embodiment of the present invention, the vacuum residue has a penetration in the range of 50 to 150 dmm. Preferably, the vacuum residue has a penetration range of 80 to 150 dmm.

In an embodiment of the present invention, the nitrogen rich polycyclic aromatic hydrocarbon comprises a polycyclic aromatic hydrocarbon condensed with a heterocyclic ring containing nitrogen. The nitrogen rich polycyclic aromatic hydrocarbon includes polycyclic aromatic hydrocarbon condensed with heterocyclic ring containing nitrogen like pyrrole, pyridine, pyrimidine, porphyrine ring or containing amide functional groups, etc. In an embodiment, the nitrogen rich polycyclic aromatic hydrocarbon is present in the range of 1-6 wt % based on the total weight of composition.

The functionalized polymer, used in accordance with the present invention, is a copolymer having ethylene or propylene backbone with side chain having functional groups wherein the functional groups comprise methacrylates, butyl acrylates vinyl ether, glycidyl methacrylate, glycidyl vinyl ether and epoxides. In an embodiment, the functionalized polymer is present in the range of 1.5-3 wt % based on the total weight of composition.

The nitrogen rich polycyclic aromatic hydrocarbon opens the epoxide rings of functionalized polymer. Addition of nitrogen rich polycyclic aromatic hydrocarbon to the composition exposes more reactive sites for the functionalized polymer, thereby preventing intra-molecular reactions between the functionalized polymer and ultimately prevents gelling in bitumen composition. Addition of nitrogen rich polycyclic aromatic hydrocarbon increases the hardening and its interaction with functionalized polymer shows synergistic effect on softening point of polymer modified bitumen composition.

Present invention also provides a process for preparing a polymer modified bitumen composition. In an embodiment, the polymer modified bitumen used according to the present invention is produced by a process comprising the step of reacting a functionalized polymer with a nitrogen rich polycyclic aromatic hydrocarbon modified vacuum residue. The reaction is conducted within 6 hours in the absence of a catalyst. In an embodiment of the present invention, the reaction is conducted in a batch reactor without milling.

In yet another embodiment, a process for preparing a PMB is disclosed, wherein nitrogen rich polycyclic aromatic hydrocarbon is added to heated Vacuum Residue, and is mixed properly or dispersed homogenously with the help of agitator for half to one hour. The functionalized polymer is added to the heated modified residue and mixed with the help of agitator for 4-5 hrs. The temperature is maintained at 165-185° C. throughout the process.

In an embodiment of the present invention, the nitrogen rich polycyclic aromatic hydrocarbon comprises a polycyclic aromatic hydrocarbon condensed with a heterocyclic ring containing nitrogen. The nitrogen rich polycyclic aromatic hydrocarbon includes polycyclic aromatic hydrocarbon condensed with heterocyclic ring containing nitrogen like pyrrole, pyridine, pyrimidine, porphyrine ring or containing amide functional groups, etc. In an embodiment, the nitrogen rich polycyclic aromatic hydrocarbon is present in the range of 1-6 wt % based on the total weight of composition.

The functionalized polymer, used in accordance with the present invention, is a copolymer having ethylene or propylene backbone with side chain having functional groups wherein the functional groups comprise methacrylates, butyl acrylates vinyl ether, glycidyl methacrylate, glycidyl vinyl ether and epoxides. In an embodiment, the functionalized polymer is present in the range of 1.5-3 wt % based on the total weight of composition.

In the present invention, various blends of functionalized polymer in nitrogen rich polycyclic aromatic hydrocarbon modified heavy hydrocarbon based vacuum residue were prepared and their physical characteristics were tested against a standard of conventional paving grade asphalt. Several blends were prepared using nitrogen rich polycyclic aromatic hydrocarbon (1-6%) with functionalized polymer (1.5-3%) in vacuum residue without using catalyst. The weight percentages were based on the total weight of the mixture. The PMB, prepared in accordance with the present invention meets specifications PMB-40s per IS 15462:2004: Type-B/IRC: SP: 53-2010.

The following test procedures were used in evaluating the analytical properties of the mixtures herein and in evaluating the physical properties of the mixtures of the examples.

### Ring and Ball Softening Point (RBSP); ASTM D36:

The softening point is useful in the classification of bitumen, as one element in establishing the uniformity of shipments or sources of supply, and is indicative of the tendency of the material to flow at elevated temperatures encountered in service. This test method covers the determination of the softening point of bitumen in the range from 30 to 157° C. [86 to 315° F.] using the ring-and-ball apparatus immersed in distilled water [30 to 80° C.] or USP glycerin (above 80 to 157° C.). The values stated in either SI units or inch-pound units are to be regarded separately as standard. The values stated in each system may not be exact equivalents; therefore, each system shall be used independently of the other. Combining values from the two systems may result in non-conformance with the standard.

### Penetration Hardness; ASTM D5:

Specimens are prepared in sample containers exactly as specified (ASTM D5-97) and placed in a water bath at the prescribed temperature of test for 1 to 1.5 hours before the test. For normal tests the precisely dimensioned needle, loaded to 100±0.05 g, is brought to the surface of the specimen at right angles, allowed to penetrate the bitumen for 5±0.1 s, while the temperature of the specimen is maintained at 25±0.1° C. The penetration is measured in tenths of a millimetre (deci-millimetre, d-mm) Make at least three determinations on the specimen. A clean needle is used for each determination. In making repeat determinations, start each with the tip of the needle at least 10 mm from the side of the container and at least 10 mm apart.

### Elastic Recovery ASTM D6084-06:

This test method is useful in confirming that a material has been added to the asphalt to provide a significant elastomeric characteristic. It does not necessarily identify the type or amount of material added. This test method covers the elastic recovery of a bituminous material measured by the recoverable strain determined after severing an elongated briquette specimen of the material of the form described in. The specimens are pulled to a specified distance at a specified speed and at a specified temperature. Unless otherwise specified, the test shall be made at a temperature of 15° C. and with a speed of 5 cm/min

### Rotational Viscometer (RV); ASTM D4402/D4402M:

Some asphalts may exhibit non-Newtonian behaviour under the conditions of this test method, or at temperatures within the range of this test method. Since non-Newtonian viscosity values are not absolute properties, but reflect the behaviour of the fluid within the particular measurement system, it should be recognized that measurements made by this test method may not always predict field performance under the conditions of use. Comparisons between non-Newtonian viscosity values should be made only for measurements made with similar conditions of temperature, shear rate, and shear history. This test method outlines a procedure for measuring the apparent viscosity of asphalt from 38 to 260° C. [100 to 500° F.] using a rotational viscometer and a temperature-controlled thermal chamber for maintaining the test temperature. The values stated in either SI units or inch-pound units are to be regarded separately as standard. The values stated in each system may not be exact equivalents; therefore, each system shall be used independently of the other. Combining values from the two systems may result in non-conformance with the standard.

Rolling this Film Oven (RTFO); ASTM D2872:

The test indicates approximate changes that occur in Bitumen during hot-mixing process of road construction.
Test Conditions: Temperature=163° C., Test duration=85 minutes, Air Flow rate=4 L/min
35 g of sample taken in glass container heated in RTFO under the test conditions.
Effect of heat and air is determined from the change occurred in the value of absolute Viscosity of the residue.

Dynamic Shear, ASTM D7175, is determined both before and after simulated aging in the Rolling Thin Film Oven (RTFO) to determine performance grading of modified asphalt.

Bending Beam Creep Stiffness, ASTM D 6648, is determined after RTFO and PAV aging. The Bending Beam Creep Stiffness test measures low temperature stiffness characteristics. A 12.7 cm×0.6 cm×1.3 cm (5″×¼″×½″) beam of binder material is molded, cooled to testing temperature, and subjected to an imposed weight load. Load versus deflection data is collected for 240 seconds. The low temperature specification values are based on the stiffness value determined at 60 seconds and the absolute value of the slope (m-value) of the time vs. log (stiffness) curve determined at 60 seconds.

### Evaluation of Anti-Stripping Properties:

Based both on laboratory and field testing, there are different performance tests, for evaluating anti-stripping properties developed over the years but none is accepted fully as correlating with real field conditions. These tests have been classified in different categories such as Dynamic Immersion tests, Static Immersion tests, Water Boiling tests, Chemical Immersion tests, Abrasion tests; Simulated Traffic tests Quantitative Coating Evaluation tests, Non-Destructive tests, and Immersion-Mechanical tests. Boiling water test, Marshall Stability test and freeze-thaw test are commonly practiced to quickly judge the anti-stripping properties of various chemicals and aggregates. Some of these tests are included in relevant ASTM D 3625-96 or IS.6241/71 specifications.

Hot water immersion test was used for evaluation of antistripping of polymer modified asphalt under this invention and a summary of the tests are as follows:

### Hot Water Immersion Tests:

Boiling Water Test is a visual rating of the extent of stripping after the mixture is boiled. 238 grams of washed and dry aggregate and the 12 gm of melted bitumen is doped with the anti-stripping agent, mixed properly and are kept in oven at 85-100° C. Then a 2,000 ml beaker is filled halfway with distilled water and boiled. The mixture is placed in boiling water for 10 minutes. Asphalt cement that is floating is skimmed off from the top. The water is cooled to room temperature and then poured off. The aggregate mixture is emptied onto a white paper towel and graded, then visually observed for the remaining percentage of coated area (not stripped by water). After 24 hours the aggregate mixture is observed again.

Several blends of modified asphalt in the present invention have been tested for hot water immersion tests and Physico-chemical test. These tests confirm acceptability of developed product with regard to anti-stripping properties and their performance well comparable to commercial products, currently being used by oil industry.

It is found that the combination of nitrogen rich polycyclic aromatic hydrocarbon with functionalized polymer in vacuum residue has synergistic effect on softening point and provides the polymer modified asphalt without using catalyst with high stability, reduced deformation, reduced temperature susceptibility, and enhanced resistance to water stripping as compared to functionalized polymer modified bitumen. All grades of polymer modified bitumen as per IS 15462:2004: Type-B/IRC: SP 53-2010 can be prepared without using catalyst and high shear milling process.

Having described the basic aspects of the present invention, the following non-limiting examples illustrate specific embodiment thereof.

### Example 1

### Effect of the Components Nitrogen Rich Hydrocarbon and Functionalized Polymer when Penetration Range is 40 and when Penetration Range is More than 150

Asphalt was heated to a temperature of about 165-185° C. wherein the nitrogen rich polycyclic aromatic hydrocarbon was added and reaction mixture was agitated for half to two hrs. Then functionalized polymer was introduced and reaction mixture was further agitated for 4 hrs, the polymer was completely dispersed and then sample was taken and following measurements were carried out to monitor the formation of polymer modified bitumen.

TABLE 1

| | | Nitrogen Rich | Functionalized | | | |
|---|---|---|---|---|---|---|
| | | Hydrocarbon | Polymer | | | |
| S.N. | Asphalt | (%) | (%) | Penetration | Results | Inference |
| 1. | (Pen: 40) | 2 | 1.5 | <30 | — | Fail |
| 2. | (Pen: 160) | 4 | 3 | — | Gelling | Fail |
| | | | | | Occurs | |

Inference:

Test result does not meet the requirement of polymer modified bitumen specification at below penetration range of 50. Texture of bitumen has been collapsed if the penetration range was increased beyond 150.

### Example-2

### Effect of the Components Nitrogen Rich Hydrocarbon and Functionalized Polymer when Penetration Range is within 80 to 150

In Table 2 is shown a process for preparing a composition in the present invention comprising:
1. 94 weight percent, based upon the composition, of asphalt having penetration range 80-100 dmm.
2. 4 weight percent, based upon the composition, of nitrogen rich polycyclic aromatic hydrocarbon.
3. 2 weight percent, based upon the composition, of a functionalized polymer (polymer includes ethylene or propylene back bone with side chain having functional groups like methacrylates, vinyl ether, glycidyl methacrylate, glycidyl butyl acrylates, glycidyl vinyl ether, epoxides etc.)

Asphalt was heated to a temperature of about (165-185° C.) wherein the nitrogen rich polycyclic aromatic hydrocarbon was added and reaction mixture was agitated for half to two hrs. Then functionalized polymer was introduced and reaction mixture was further agitated for 4 hrs, the polymer was completely dispersed and then sample was taken and following measurements were carried out to monitor the formation of polymer modified bitumen.

TABLE 2

| | | Nitrogen Rich | Functionalized | | | Elastic |
|---|---|---|---|---|---|---|
| S.N. | Asphalt | Hydrocarbon | Polymer (%) | Soft. Pt. | Penetration | Recovery |
| 1. | (Pen: 80-100) | 4 | 2 | 67 | 43 | 71 |

Inference:

Test data in above table meets with the required PMB-40 specification.

### Example-3

In Table 3 is shown a process for preparing a composition in the present invention comprising:
1. 92 weight percent, based upon the composition, of HSVR (high sulphur vacuum residue) having penetration range 112 dmm.
2. 6 weight percent, based upon the composition, of nitrogen rich polycyclic aromatic hydrocarbon.
3. 2 weight percent, based upon the composition, of a functionalized polymer (polymer includes ethylene or propylene back bone with side chain having functional groups like methacrylates, vinyl ether, glycidyl methacrylate, glycidyl butyl acrylates, glycidyl vinyl ether, epoxides etc.)

HSVR was heated to a temperature of about (165-185° C.) wherein the nitrogen rich polycyclic aromatic hydrocarbon was added and reaction mixture was agitated for half to two hrs. Then functionalized polymer was introduced and reaction mixture was further agitated for 4 hrs, the polymer was completely dispersed and then sample was taken and following measurements were carried out to monitor the formation of polymer modified bitumen.

TABLE 3

| | | Nitrogen Rich | Functionalized | | | Elastic |
|---|---|---|---|---|---|---|
| S.N. | HSVR | Hydrocarbon | Polymer (%) | Soft. Pt. | Penetration | Recovery |
| 1. | (Pen: 112) | 6 | 2 | 66 | 43 | 85 |

Inference:

Test data in above table meets with the required PMB-40 specification.

### Example-4

### Energy Saving in Terms of Shorter Processing Times and Lower Processing Temperatures for the Production of Product Polymer Modified Asphalt Composition

A comparative prior art formulation, polymer modified asphalt 1, formulation 1 containing functionalized polymer was made by combining Asphalt (Pan: 80-100): Asphalt having penetration range from 80-100.

Functionalized polymer: polymer includes ethylene or propylene back bone with side chain having functional groups like methacrylates, vinyl ether, glycidyl methacrylate, glycidyl butyl acrylates, glycidyl vinyl ether, epoxides etc.

In this manner Asphalt (Pen: 80-100), was heated to a temperature of about 185° C. wherein the functionalized polymer was introduced. The reaction mixture was agitated for four hours, the polymer was completely dispersed and then reaction sample was taken and following measurements were carried out to monitor the formation of desired polymer modified asphalt.

TABLE 4

| | | Functionalized | Softening | | Elastic | |
|---|---|---|---|---|---|---|
| S.N. | Asphalt | Polymer (%) | Pt. | Penetration | Recovery | Inference |
| 1. | (Pen: 80-100) | 2 | 56 | 54 | 60 | Fail against |
| | | | | | | PMB-40 |
| | | | | | | specification |

A comparative prior art formulation 2, containing functionalized polymer and catalyst was made by combining Asphalt (Pen: 80-100): Asphalt having penetration range from 80-100.

Functionalized polymer: polymer includes ethylene, propylene back bone and side chains having functional groups like methacrylates, vinyl ether, glycidyl methacrylate, glycidyl butyl acrylates, glycidyl vinyl ether, epoxides etc.

Catalyst: Polyphosphoric acid, any proton donor catalyst etc.

In this manner Asphalt (Pen: 80-100), was heated to a temperature of about 185° C. wherein the functionalized polymer was introduced. The reaction mixture was agitated for four hours, the polymer was completely dispersed and then catalyst was added and reaction mixture was further agitated for one hour reaction then sample was taken and following measurements were carried out to monitor the formation of desired polymer modified asphalt.

TABLE 5

| | | Functionalized | Catalyst | | Infer- |
|---|---|---|---|---|---|
| S.N. | Asphalt | Polymer (%) | (%) | Observation | ence |
| 1. | (Pen: 80-100) | 2-3 | 0.15 | Gelling Occurs | Fail |

Present Invention:

To illustrate the improvement over prior art, Polymer modified asphalt Formulation 3, according to present invention, was made by combining asphalt (Pen: 80-100): Asphalt having penetration range from 80-100.

Functionalized polymer includes ethylene or propylene back bone with side chain having functional groups like acrylates, methacrylates, butyl acrylates, vinyl ether, glycidyl methacrylate, glycidyl vinyl ether, epoxides etc.

Nitrogen rich polycyclic aromatic hydrocarbon: The nitrogen rich polycyclic aromatic hydrocarbon includes polycyclic aromatic hydrocarbon condensed with heterocyclic ring containing nitrogen like pyrrole, pyridine, pyrimidine, porphyrine ring, amide functional groups, etc.

In this manner asphalt (Pen: 80-100) was heated to a temperature of about 165-185° C. wherein the nitrogen rich polycyclic aromatic hydrocarbon was added and reaction mixture was agitated for 1-2 hours then functionalized polymer was introduced and reaction mixture was further agitated for four to five hours, the polymer was completely dispersed and then sample was taken and following measurements were carried out to monitor the formation of desired polymer modified asphalt.

A comparison of polymer modified asphalt formulation 1, 2 and 3 indicates that the effect of adding nitrogen heterocycles along with functionalized polymer reduces the reaction temperature to get desired cost effective polymer modified with improved properties. Shorter processing times and lower processing temperatures mean economic saving in terms of having the final product polymer modified asphalt composition more quickly available and in terms of freeing processing equipment for further re-use.

TABLE 6

| | | Nitrogen | Functionalized | | | | |
|---|---|---|---|---|---|---|---|
| | | Rich | Polymer | Soft. | | Elastic | |
| S.N. | Asphalt | Hydrocarbon | (%) | Pt. | Penetration | Recovery | Inference |
| 1. | (Pen: 80-100) | 3-4 | 1.8-2 | 67 | 43 | 71 | Pass |

Inference:

Test results of table 6 only fulfill the requirement of polymer modified bitumen (PMB-40).

### Example-5

### Enhanced Softening Point Due to the Addition of Nitrogen Rich Polycyclic Hydrocarbon Along with Functionalized Polymer in Heavy Hydrocarbon

Softening point increases continuously with the addition of either nitrogen rich polycyclic aromatic hydrocarbon or functionalized polymer in petroleum residue, but at a certain point it becomes constant.
According to present invention as we claim, the combination of nitrogen rich polycyclic aromatic hydrocarbon and functionalized shows synergic effect on softening point as shown in table as given below.
HSVR (112-Pen): High sulphur vacuum residue having penetration 112.

TABLE 7

| | | Nitrogen Rich | | |
|---|---|---|---|---|
| | HSVR (112- | Hydrocarbon | Functionalized | S.P |
| S.N. | Pen) | (%) | Polymer (%) | (° C.) |
| 1. | HSVR-112Pen | 1 | 0 | 45 |
| 2. | HSVR-112Pen | 2 | 0 | 45 |
| 3. | HSVR-112Pen | 3 | 0 | 48 |
| 4. | HSVR-112Pen | 4 | 0 | 49 |
| 5. | HSVR-112Pen | 0 | 1.5 | 53 |
| 5. | HSVR-112Pen | 0 | 2 | 59 |
| 6. | HSVR-112Pen | 0 | 2.5 | 59 |
| 7. | HSVR-112Pen | 0 | 3 | 59 |
| 8. | HSVR-112Pen | 6 | 2 | 66 |
| 9. | Asphalt | 0 | 2 | 56 |
| | (Pen: 80-100) | | | |
| 10. | Asphalt | 4 | 2 | 67 |
| | (Pen: 80-100) | | | |

### Example-6

### Good Antistripping Effect Due to the Addition of Nitrogen Rich Polycyclic Hydrocarbon Along with Functionalized Polymer in Petroleum Residue

As we claim, in the present invention, the combination of nitrogen rich polycyclic aromatic hydrocarbon with functionalized polymer shows good antistripping effect as compared to neat bitumen and addition of functionalized polymer in asphalt alone.

TABLE 8

| | | Nitrogen Rich | | |
|---|---|---|---|---|
| | | Hydrocarbon | Functionalized | Antistripping |
| S.N. | Asphalt | (%) | Polymer (%) | Effect (%) |
| 1. | Asphalt | 0 | 0 | 40-45 |
| | (Pen: 80-100) | | | |
| 2. | Asphalt | 0 | 2 | 90-92 |
| | (Pen: 80-100) | | | |
| 3. | Asphalt | 4 | 2 | 95-98 |
| | (Pen: 80-100) | | | |

### Example-7

### Enhanced Elastic Recovery Due to the Addition of Nitrogen Rich Polycyclic Hydrocarbon Along with Functionalized Polymer in Asphalt without Adding Catalyst

As we claim, according to present invention, polymer modified asphalt can be prepared by adding rich polycyclic aromatic hydrocarbon along with functionalized polymer to asphalt.
Homogenous blends can be prepared by adding nitrogen rich polycyclic aromatic hydrocarbon in asphalt without adding catalyst to avoid the risk of gelling.
Catalyst: Any proton donor acid, organic acid, polyphosphoric acid etc.

TABLE 9

| | | Nitrogen | | | Elastic |
|---|---|---|---|---|---|
| | | Rich | | | Recov- |
| | | Hydrocarbon | Functionalized | Catalyst | ery |
| S.N. | Asphalt | (%) | Polymer (%) | (%) | (%) |
| 1. | Asphalt | 0 | 2 | 0 | 60 |
| | (Pen: 80-100) | | | | |
| 2. | Asphalt | 4 | 0 | 0 | 20 |
| | (Pen: 80-100) | | | | |
| 3. | Asphalt | 4 | 0 | 0.15 | 20 |
| | (Pen: 80-100) | | | | |
| 4. | Asphalt | 4 | 2 | 0 | 71 |
| | (Pen: 80-100) | | | | |
| 5. | Asphalt | 0 | 2 | 0.15-0.3 | Gelling |
| | (Pen: 80-100) | | | | occurs |

### Example-8

### Higher Performance Grade Attained by Modified Asphalt Due to the Addition of Nitrogen Rich Polycyclic Aromatic Hydrocarbon Along with Functionalized Polymer in Vacuum Residue

As we claim, according to present invention, Polymer modified asphalt exhibiting improved Dynamic Shear Rheometer stiffness values for original binder as well as after RTFO of modified asphalt, which when tested with a dynamic shear rheometer at temperatures ranging from 58° to 82° C., exhibits G*/sin (δ) stiffness values which are greater than stiffness value for asphalt without adding nitrogen rich polycyclic hydrocarbon as shown in data given in table below.

TABLE 10

| | | | | | | G*/Sin δ | |
|---|---|---|---|---|---|---|---|
| | | Nitrogen | | | | For | |
| | | Rich | Fun. | | | Orig. > 1Kpa | Pass/ |
| | | Hydrocarbon | Polymer | | | For | Fail |
| S.N. | Asphalt | (%) | (%) | Neat/Aged | Temp | RTFO > 2.2Kpa | Temp. |
| 1. | (Pen: 80-100) | 0 | 0 | Neat | 58° C. | 1.91 | 62° C. |
| | | | | | 64° C. | 0.98 | |
| | | | | | 70° C. | 0.50 | |
| 2. | (Pen: 80-100) | 4 | 2 | Neat | 58° C. | 7.62 | 75.7° C. |
| | | | | | 64° C. | 3.80 | |
| | | | | | 70° C. | 1.96 | |
| 3. | (Pen: 80-100) | 4 | 2 | RTFO | 58° C. | 26.21 | 82.8° C. |
| | | | | | 64° C. | 13.43 | |
| | | | | | 70° C. | 7.17 | |
| | | | | | 76° C. | 4.03 | |
| | | | | | 82° C. | 2.35 | |
| 4. | HSVR | 0 | 0 | Neat | 58° C. | 1.26 | 58° C. |
| | (112-Pen) | | | | 64° C. | 0.69 | |
| | | | | | 70° C. | 0.39 | |
| 5. | HSVR | 6 | 2 | Neat | 58° C. | 7.61 | 75.4° C. |
| | (112-Pen) | | | | 64° C. | 3.81 | |
| | | | | | 70° C. | 1.83 | |
| | | | | | 76° C. | 0.93 | |
| 6. | HSVR | 6 | 2 | RTFO | 58° C. | 24.32 | 81.7° C. |
| | (112-Pen) | | | | 64° C. | 12.65 | |
| | | | | | 70° C. | 6.73 | |
| | | | | | 76° C. | 3.56 | |
| | | | | | 82° C. | 2.15 | |

Inference:

Comparative results of test data shows that the developed polymer modified bitumen has high performance grade and possess high temperature rutting resistance properties than neat bitumen.

### Example-9

### Low Temperature Creep Stiffness Effect Attained by Modified Asphalt Due to the Addition of Nitrogen Rich Polycyclic Aromatic Hydrocarbon Along with Functionalized Polymer in Vacuum Residue

As we claim according to present invention, the modified asphalt exhibits acceptable and approximately same data for low temperature creep stiffness and “m” values as those exhibited by the asphalt without adding functionalized polymer and nitrogen rich polycyclic aromatic hydrocarbon, when tested at low temperatures ranging from −42° C. to 0° C. according to ASTM D6648 test method. A comparative study of Bending Beam Creep Stiffness test data for the various blends having different composition is given as follows.

TABLE 11

| | | Nitrogen | | | | | |
|---|---|---|---|---|---|---|---|
| | | Rich | Fun. | | | Estimated | |
| | | Hydrocarbon | Polymer | | | Stiff. | m- |
| S.N. | Asphalt | (%) | (%) | Neat/Aged | Temp. | (MPa) | Value |
| 1. | (Pen: 80-100) | 0 | 0 | Neat | −18° C. | 229 | 0.355 |
| 2. | (Pen: 80-100) | 0 | 2 | Neat | −12° C. | 112 | 0.427 |
| 3. | (Pen: 80-100) | 0 | 2 | Neat | −18° C. | 269 | 0.331 |
| 4. | (Pen: 80-100) | 4 | 0 | Neat | −12° C. | 109 | 0.420 |
| 5. | (Pen: 80-100) | 4 | 2 | Neat | −6° C. | 52.7 | 0.505 |
| 6. | (Pen: 80-100) | 4 | 2 | Neat | −12° C. | 168 | 0.367 |
| 7. | (Pen: 80-100) | 4 | 2 | Neat | −18° C. | 320 | 0.300 |
| 8. | (Pen: 80-100) | 4 | 2 | RTFO | −6° C. | 63.8 | 0.475 |
| 9. | (Pen: 80-100) | 4 | 2 | RTFO | −12° C. | 167 | 0.370 |
| 10. | (Pen: 80-100) | 4 | 2 | RTFO | −18° C. | 321 | 0.311 |
| 11. | HSVR | 6 | 2 | Neat | −6° C. | 37.8 | 0.520 |
| | (112-Pen) | | | | | | |
| 12. | HSVR | 6 | 2 | Neat | −12° C. | 94.6 | 0.420 |
| | (112-Pen) | | | | | | |
| 13. | HSVR | 6 | 2 | Neat | −18° C. | 220 | 0.330 |
| | (112-Pen) | | | | | | |
| 14. | HSVR | 6 | 2 | RTFO | −6° C. | 51.5 | 0.482 |
| | (112-Pen) | | | | | | |
| 15. | HSVR | 6 | 2 | RTFO | −12° C. | 123 | 0.390 |
| | (112-Pen) | | | | | | |
| 16. | HSVR | 6 | 2 | RTFO | −18° C. | 274 | 0.317 |
| | (112-Pen) | | | | | | |

Inference:

Results of test data shows that the developed polymer modified bitumen has good low temperature thermal cracking resistance properties than neat bitumen.

### Example-10

### Production of all Grade of PMB as Per IS 15462:2004(Type-B)/IRC: SP: 53-2010

In the present invention, all grades of polymer modified bitumen can be produced by using combination of nitrogen rich polycyclic aromatic hydrocarbon with functionalized polymer in vacuum residue without gelling and without using catalyst in less than 6 hrs.

### Example-11

### Comparison of Performance Data by Using Functionalized Polymer with Catalyst and by Using Functionalized Polymer Along with Nitrogen Rich Polycyclic Aromatic Hydrocarbon in Vacuum Residue

Comparison of Low temperature creep stiffness test data between PMB-70 obtained by using functionalized polymer along with catalyst and by using combination of nitrogen rich polycyclic aromatic hydrocarbon with functionalized polymer shows that creep stiffness of both PMB-70 is almost comparable as shown below.

TABLE 12

| | | | | Estimated | |
|---|---|---|---|---|---|
| | | Neat/ | | Stiff. | m- |
| S.N. | PMB | Aged | Temp. | (MPa) | Value |
| 1. | PMB-70 | Neat | −6° C. | 28.7 | 0.482 |
| | (using N-rich | | | | |
| | hydrocarbon + | | | | |
| | Func. Polymer) | | | | |
| 2. | PMB-70 | Neat | −12° C. | 168 | 0.391 |
| | (using N-rich | | | | |
| | hydrocarbon + | | | | |
| | Func. Polymer) | | | | |
| 3. | PMB-70 | Neat | −18° C. | 289 | 0.336 |
| | (using N-rich | | | | |
| | hydrocarbon + | | | | |
| | Func. Polymer) | | | | |
| 4. | PMB-70 | Neat | −6° C. | 29.6 | 0.502 |
| | (Func. Polymer + PPA) | | | | |
| 5. | PMB-70 | Neat | −12° C. | 170 | 0.393 |
| | (Func. Polymer + PPA) | | | | |
| 6. | PMB-70 | Neat | −18° C. | 291 | 0.337 |
| | (Func. Polymer + PPA) | | | | |

Comparison of Dynamic Shear Rheometer stiffness values for original binder of modified asphalt by using functionalized polymer along with catalyst and by using combination of nitrogen rich polycyclic aromatic hydrocarbon with functionalized polymer which when tested with a dynamic shear rheometer at temperatures ranging from 58° to 82° C., shows that G*/sin (δ) stiffness values of both PMB-70 shows that both polymer modified asphalt has to be same graded i.e. 76° C. as shown below.

TABLE 13

| | | | | G*/Sin δ |
|---|---|---|---|---|
| | | | | For |
| | | | | Orig. >1 Kpa |
| | | | | For |
| S.N. | PMB | Neat/Aged | Temp. | RTFO >2.2 Kpa |
| 1. | PMB-70 | Neat | 58° C. | 8.30 |
| | (using N-rich | | 64° C. | 4.68 |
| | hydrocarbon + | | 70° C. | 2.31 |
| | Func. Polymer) | | 76° C. | 1.34 |
| 2. | PMB-70 | Neat | 58° C. | 8.34 |
| | (Func. Polymer + PPA) | | 64° C. | 4.79 |
| | | | 70° C. | 2.75 |
| | | | 76° C. | 1.60 |

We claim:

1. A polymer modified bitumen composition comprising:
(a) a petroleum vacuum residue;
(b) a nitrogen rich polycyclic aromatic hydrocarbon; and
(c) a functionalized polymer.

2. The polymer modified bitumen composition of claim 1, wherein the petroleum vacuum residue is produced from high sulphur crude or low sulphur crude or mixture thereof.

3. The polymer modified bitumen composition of claim 1, wherein the petroleum vacuum residue has a penetration range of 50 to 150 dmm or 80 to 150 dmm.

4. The polymer modified bitumen composition of claim 1, wherein the nitrogen rich polycyclic aromatic hydrocarbon comprises a polycyclic aromatic hydrocarbon condensed with a heterocyclic ring containing nitrogen.

5. The polymer modified bitumen composition of claim 4, wherein the heterocyclic ring containing nitrogen is selected from pyrrole, pyridine, pyrimidine, porphyrine ring or contains amide functional groups.

6. The polymer modified bitumen composition of claim 1, wherein the nitrogen rich polycyclic aromatic hydrocarbon is present in the range of 1 to 6 wt % based on the total weight of the composition.

7. The polymer modified bitumen composition of claim 1, wherein the functionalized polymer is a copolymer having ethylene or propylene backbone with side chains having functional groups.

8. The polymer modified bitumen composition of claim 7, wherein the functional groups comprise methacrylates, butyl acrylates vinyl ether, glycidyl methacrylate, glycidyl vinyl ether and epoxides.

9. The polymer modified bitumen composition of claim 1, wherein the functionalized polymer is present in the range of 1.5-3 wt % based on the total weight of the composition.

10. A process for the preparation of a polymer modified bitumen composition comprising:
(a) reacting a functionalized polymer with a nitrogen rich polycyclic aromatic hydrocarbon modified vacuum residue to obtain a polymer modified bitumen composition.

11. The process of claim 10, wherein step (a) is carried out within 6 hours in the absence of a catalyst.

12. The process of claim 10, wherein step (a) is carried out in a batch reactor without milling.

13. A process for the preparation of a polymer modified bitumen composition comprising:
i. heating petroleum vacuum residue;
ii. adding nitrogen rich polycyclic aromatic hydrocarbon to the heated petroleum residue of step i.;
iii. mixing properly or dispersing homogenously the mixture of step ii. with the help of an agitator;
iv. adding functionalized polymer to the mixture of step iii.;
v. mixing properly or dispersing homogenously the mixture of step iv. with the help of an agitator to obtain a polymer modified bitumen.

14. The process of claim 13, wherein the mixing of step iii. is carried out for half to one hour.

15. The process of claim 13, wherein the mixing of step v. is carried out for 4-5 hours.

16. The process of claim 13, wherein the process is carried out at a temperature of 165° C. to 185° C.

17. The polymer modified bitumen composition of claim 1 having enhanced softening point of 66-67° C., good antistripping effect of 95-98%, enhanced elastic recovery of 71%, higher performance grade of 76-22 and low temperature creep stiffness effect of 0.300 to 0.520.
